(19) United States
(12) Patent Application Publication
(10) Pub. No.: US 2026/0269592 A1
(43) Pub. Date: Sep. 10, 2026

(54) Overhead Electrical Powerline Break-Away Coupling by a tension clip or shear pin

(71) Applicant: Matthew James Zagaros, Ramsey, MN (US)

(72) Inventor: Matthew James Zagaros, Ramsey, MN (US)

(21) Appl. No.: 19/074,341

(22) Filed: Mar. 8, 2025

(51) Int. Cl. H02G 7/04; H01R 13/631; H01R 13/633; H01R 24/22; H01R 24/30; H01R 43/26; H01R 105/00; H02G 1/02

(52) U.S. Cl. CPC H02G 7/04; H01R 13/631; H01R 13/633; H01R 24/22; H01R 24/30; H01R 43/26; H02G 1/02; H01R 2105/00

(57) ABSTRACT

A break-away electrical coupling system for overhead power lines includes a male and female coupling body that connect mechanically and electrically via either a tension clip or shear pin. The tension clip includes a V-groove designed to fracture at a load between 50 and 250 pounds; the shear pin features a reduced-diameter section engineered to fail at a similar axial tension. The couplings include conductive prongs and spring-loaded receptacles for hot and neutral conductors, with the neutral prong extended to ensure safe last disconnection. Electrical conductors secured with grub screws, sealed with removable rubber caps. The system enables reusability of coupling housings, allows tool-free reset by replacing the clip or pin. Made of weather-resistant materials, the system is suitable for permanent and temporary applications, including utility service connections, emergency field deployments, military camps. Optional features include grounding paths, visual separation indicators, mounting loops for wedge clamps.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### STATEMENT REGARDING PRIOR DISCLOSURE BY THE INVENTOR OR A JOINT INVENTOR

Not Applicable

### BACKGROUND OF THE INVENTION

1. Overhead electrical power lines are commonly used to deliver utility power from distribution poles to residential and commercial structures. These connections are typically made via service drop cables that attach to a weatherhead or mast at the structure. In their current form, these overhead connections are vulnerable to physical strain caused by environmental conditions (such as wind, ice, or falling trees) or accidental impact (such as vehicles striking the service mast or pulling on overhead wires).
2. When such strain occurs, the force is transmitted along the conductors directly to the structure's mast or electrical service entrance, often resulting in significant structural damage, broken conduits, or exposed conductors. Additionally, when overhead wires are brought to the ground during such incidents, there is a serious risk of live conductors energizing the surrounding area, creating a hazardous situation for people and property.
3. The present invention addresses these concerns by introducing a break-away coupling designed to safely disconnect the overhead service line before damage reaches the structure. The coupling is installed in-line between the utility pole and the structure, at a distance of approximately 3 to 10 feet from the pole. When excessive tension is applied to the line, such as from a tree falling or a vehicle pulling down the cable, the coupling is engineered to separate, disconnecting the energized conductors safely and minimizing damage to the structure or mast.
4. Furthermore, the design ensures that once separated, the energized line is no longer physically or electrically connected to the structure, reducing the risk of ground-level arcing or electrical injury. Because the device is modular and non-destructive to the permanent service equipment, reconnection can be achieved quickly and easily by replacing the break-away element, restoring power with minimal downtime and repair costs.

### FIELD OF THE INVENTION

1. The present invention relates generally to overhead electrical power distribution systems, and more specifically to inline coupling devices for service drop conductors. It pertains to safety mechanisms designed to mechanically and electrically disconnect power lines under excess tension, preventing damage to connected structures and reducing electrical hazards by safely disconnecting the line before structural or electrical failure occurs.

### DESCRIPTION OF RELATED ART

1. Traditional Drop Attachments (no disconnect):
   Current utility service drops use wedge clamps, strain reliefs, and weatherheads, but none of these are designed to electrically and mechanically disconnect under tension. They merely hold the cable.
2. Fused or Breakaway Connectors (in other contexts):
   Some inline connectors in other industries (e.g., aerospace, industrial control systems) do have breakaway features, but they don't:
      Apply to high-voltage overhead service drops
      Include a dual-purpose mechanical+electrical disconnect
      Use shear pins or tension clips with engineered failure points

### BRIEF SUMMARY OF THE INVENTION

1. The present invention provides a safety-focused break-away coupling system for overhead electrical power lines. It comprises a male-side connector and a female-side connector, which are mechanically joined using either a tension clip or a shear pin. These break-away components are designed to fail at specific, pre-determined force thresholds—typically exceeding the normal service tension range of 50-100 pounds. The coupling's separation force can be precisely controlled by using interchangeable clips or pins, each rated to break at different tension values. This modular approach allows utility providers to tailor the system to local load conditions and safety requirements.
2. The coupling contains three conductive pathways: two for hot conductors and one for the neutral. The male-side connector includes metal prongs, preferably steel or another conductive material, with the two hot prongs shorter than the neutral to ensure disconnection in a safe sequence, reducing the risk of overvoltage or arcing. These are housed in an insulating enclosure composed of a durable, weather-resistant polymer such as rubber or vinyl. The female-side connector contains internal spring clamps, made from conductive metal, that engage the male prongs securely during operation.
3. When axial tension exceeds the preset limit, the clip or shear pin fractures cleanly, allowing the male and female components to separate before structural damage can occur. Once disconnected, the coupling presents a clear visual indication of failure by physically separating into two distinct parts.
4. Although designed for permanent overhead service installations, the coupling could also be used in temporary applications such as emergency medical response sites, military field operation camps, disaster recovery operations or rapid-deployment electrical systems requiring quick connection and safe disconnection.

### BRIEF DESCRIPTION OF THE SEVERAL VIEWS OF THE DRAWINGS

FIGS. 1-7 are multiple views of the tension clip.

FIG. 01 is a top view of the tension clip

FIG. 02 is a bottom view

FIG. 03 is a front view

FIG. 04 is a back view

FIG. 05 is a left-side view

FIG. 06 is a right-side view

FIG. 07 is a perspective view

FIGS. 8-14 show various views of the male-side tension clip assembly

FIG. 08 is a top view of the male-side tension clip assembly

FIG. 09 is a bottom view

FIG. 10 is a front view

FIG. 11 is a back view

FIG. 12 is a left-side view

FIG. 13 is a right-side view

FIG. 14 is a perspective view

FIGS. 15-21 show various views of the female-side tension clip assembly.

FIG. 15 is a top view of the female-side tension clip assembly

FIG. 16 is a bottom view

FIG. 17 is a front view

FIG. 18 is a back view

FIG. 19 is a left-side view

FIG. 20 is a right-side view

FIG. 21 is a perspective view

FIG. 22 is a perspective view of the male-side assembly, female-side assembly and the tension clips put together to assemble all three pieces together

FIGS. 23-29 show various views of the shear pin

FIG. 23 is a top view of the sheer pin

FIG. 24 is a bottom view

FIG. 25 is a front view

FIG. 26 is a back view

FIG. 27 is a left-side view

FIG. 28 is a right-side view

FIG. 29 is a perspective view

FIGS. 30-36 show various views of the male-side shear pin assembly.

FIG. 30 is a top view of the male-side assembly of the sheer pin

FIG. 31 is a bottom view

FIG. 32 is a front view

FIG. 33 is a back view

FIG. 34 is a left-side view

FIG. 35 is a right-side view

FIG. 36 is a perspective view

FIGS. 37-43 show various views of the female-side shear pin assembly.

FIG. 37 is a top view of the female-side assembly of the sheer pin

FIG. 38 is a bottom view

FIG. 39 is a front view

FIG. 40 is a back view

FIG. 41 is a left-side view

FIG. 42 is a right-side view

FIG. 43 is a perspective view

FIG. 44 is a perspective view of the male-side assembly with the sheer pin installed

FIG. 45 is a perspective view of the male-side assembly, the female-side assembly and the sheer pin put together to assemble all three pieces together

### DETAILED DESCRIPTION OF THE INVENTION

### First Embodiment—Tension Clip Coupling

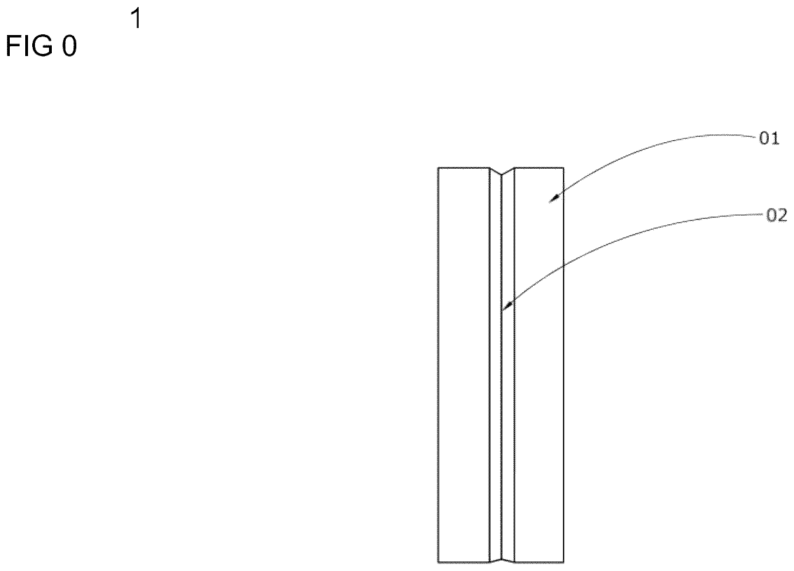

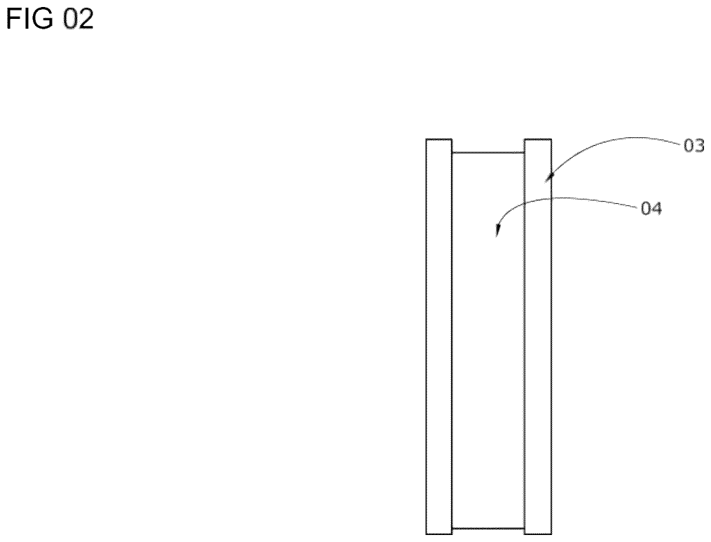

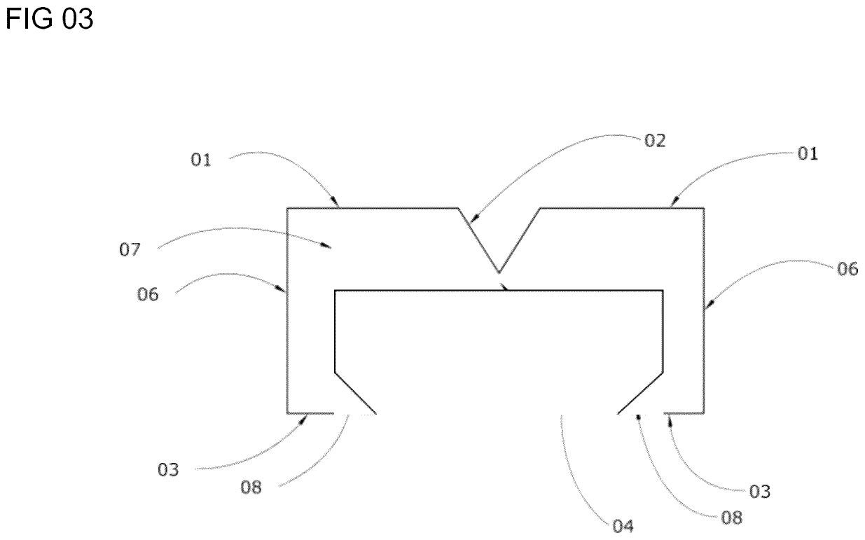

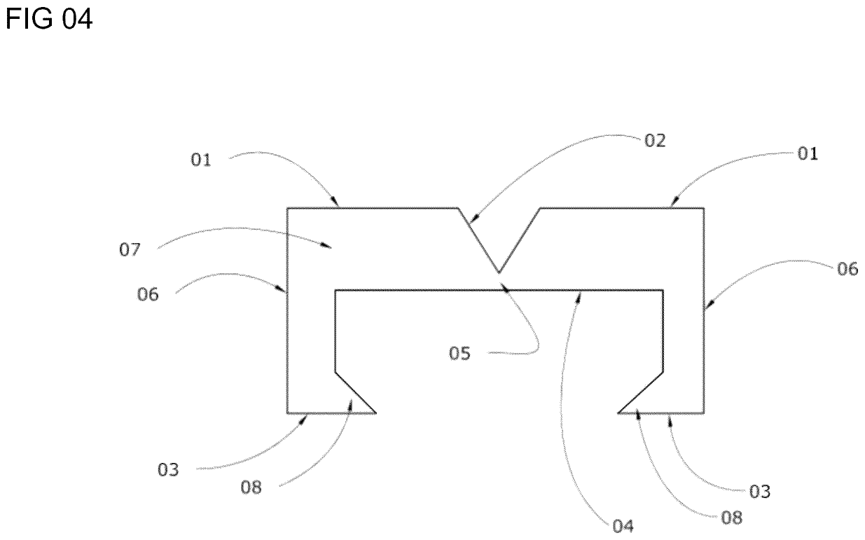

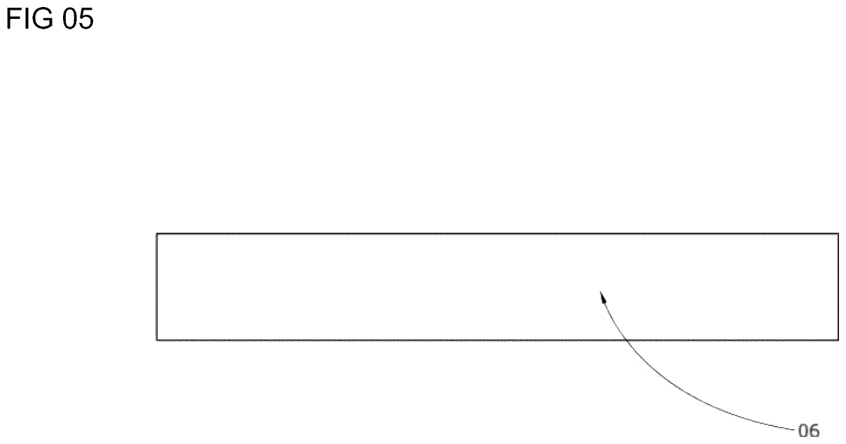

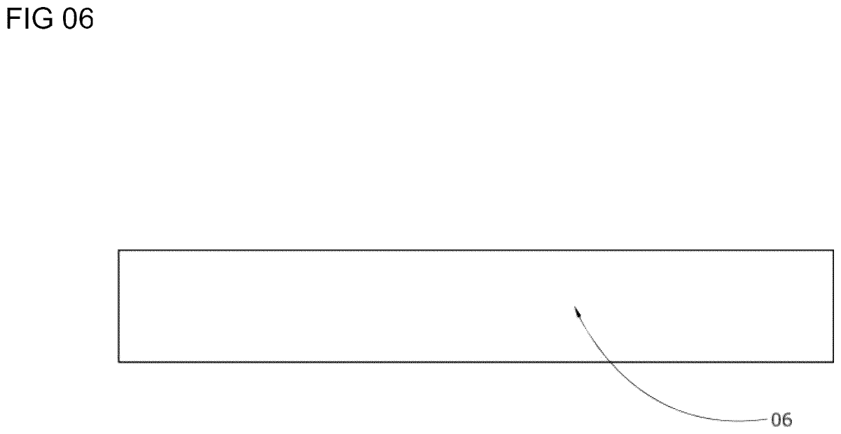

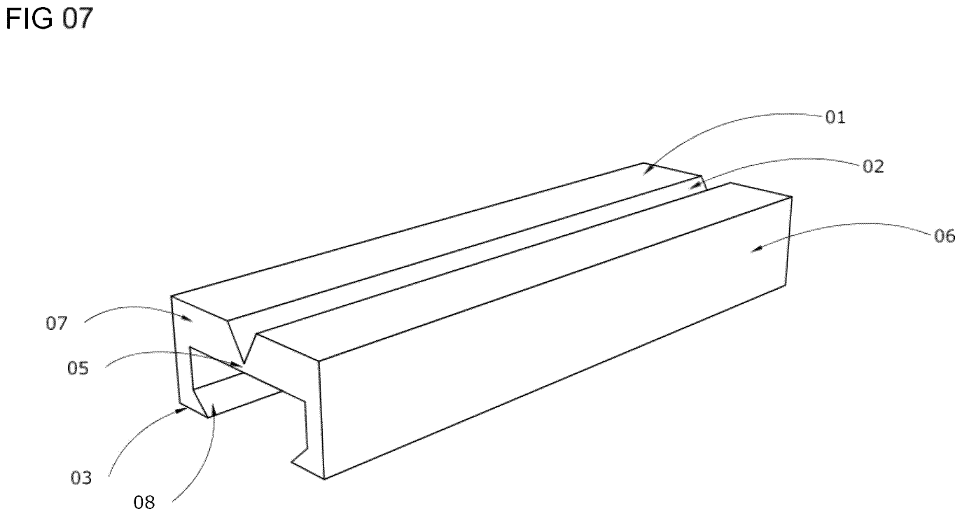

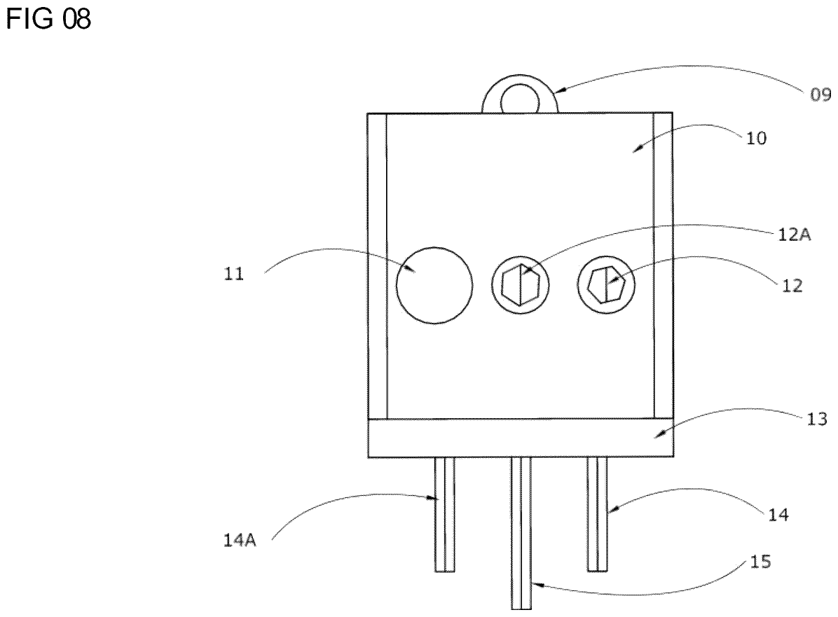

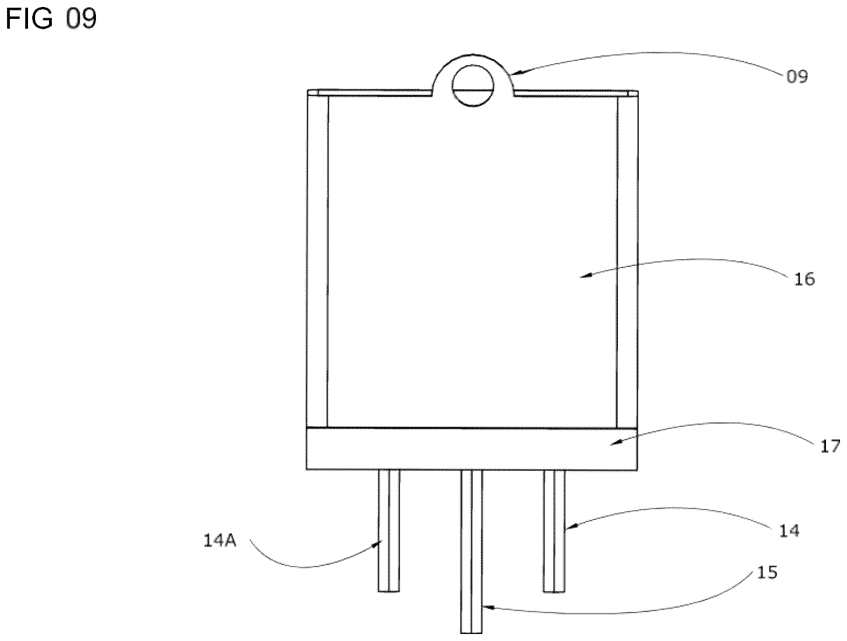

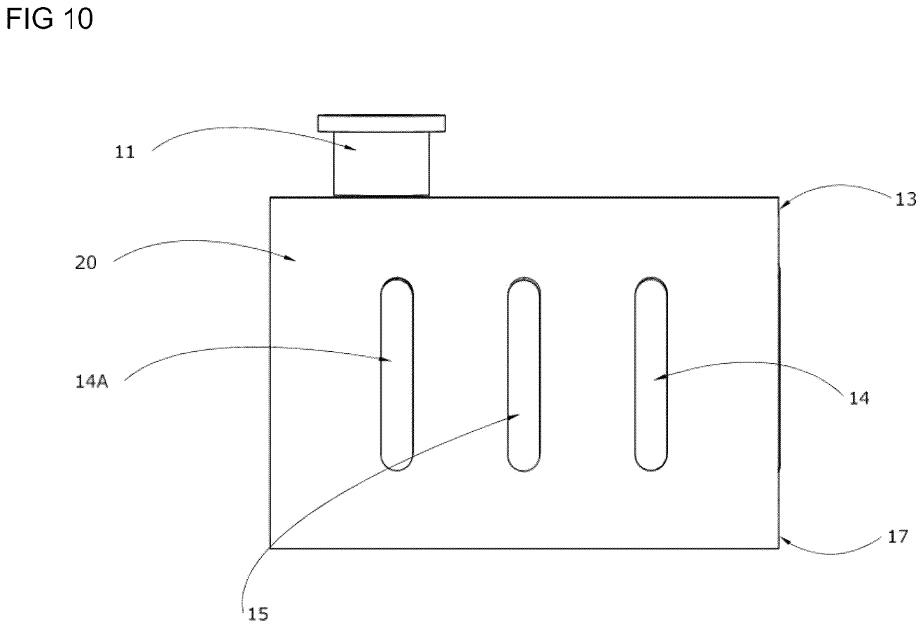

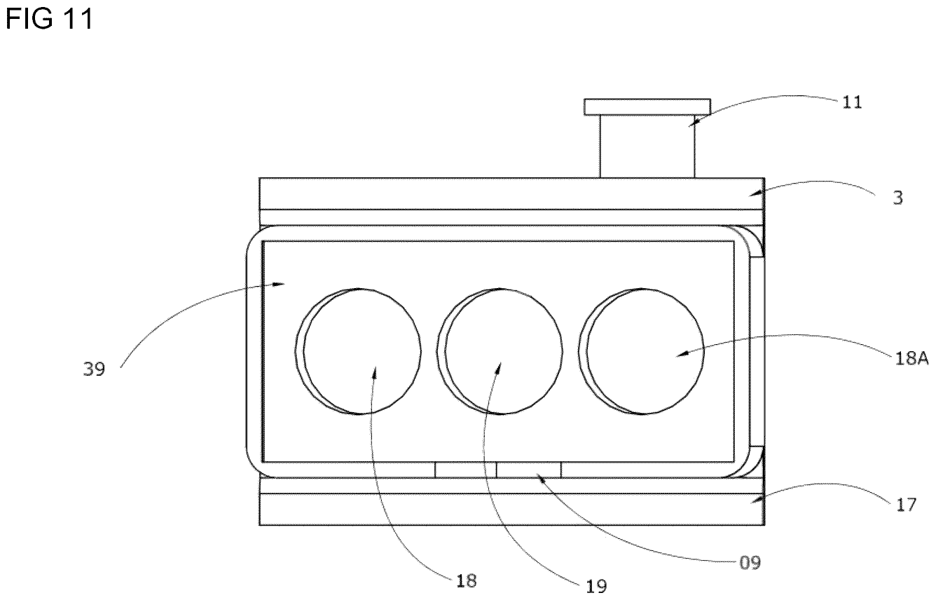

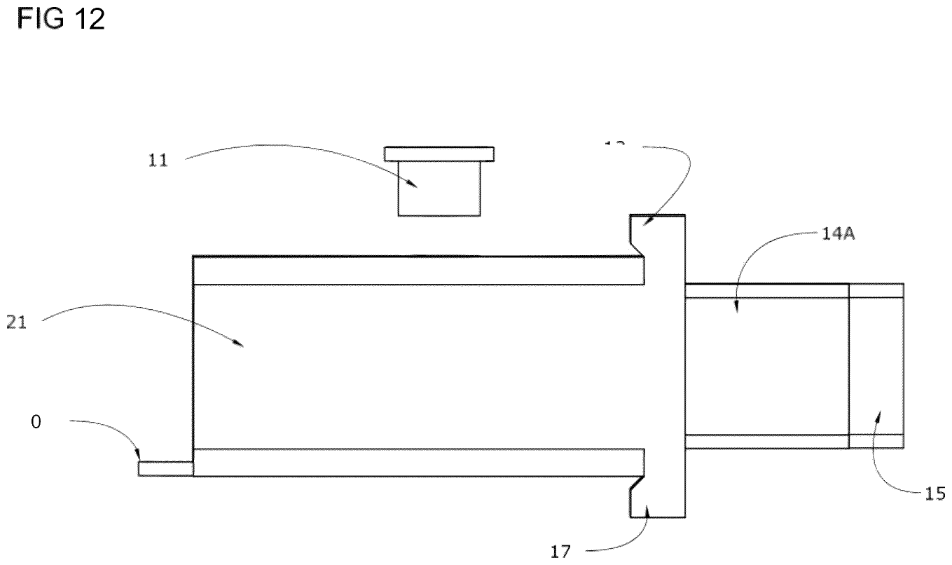

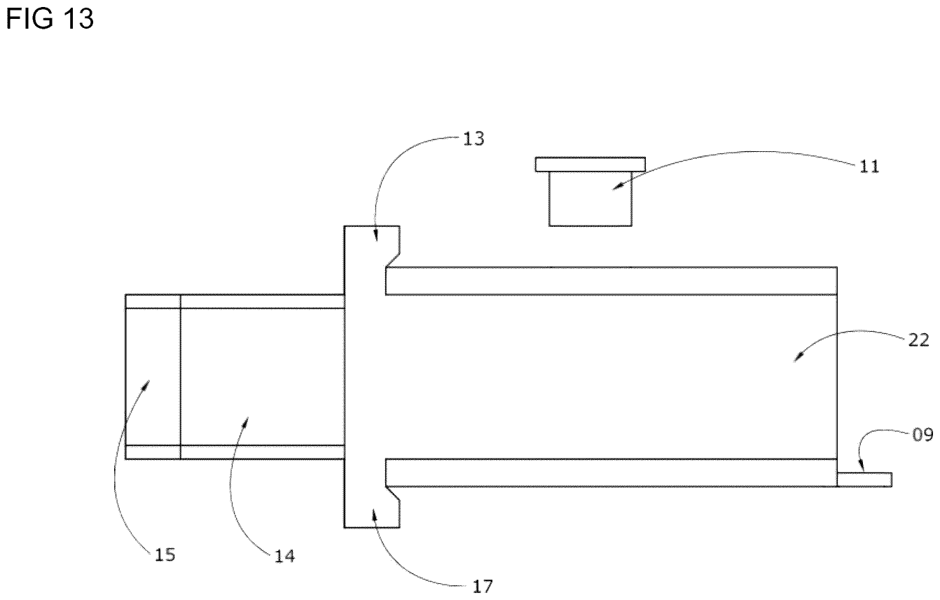

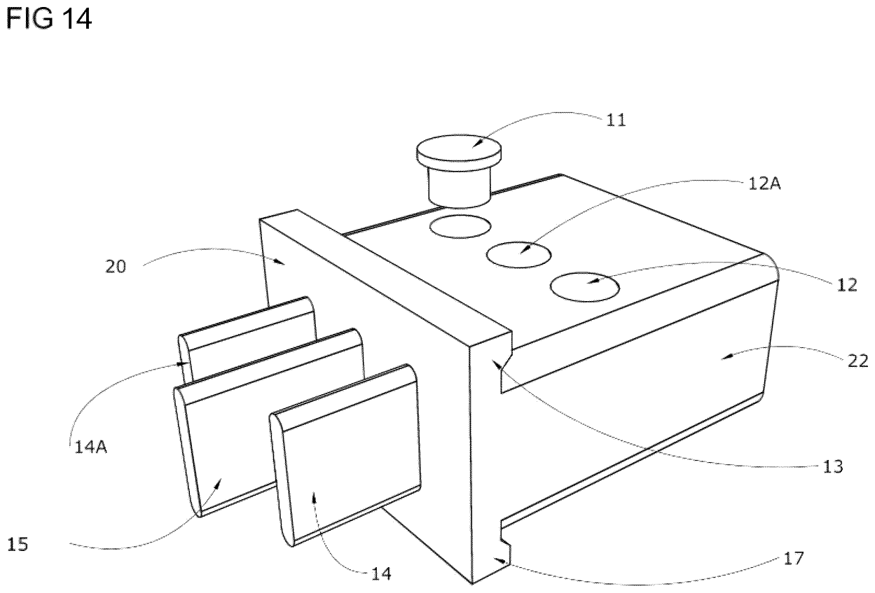

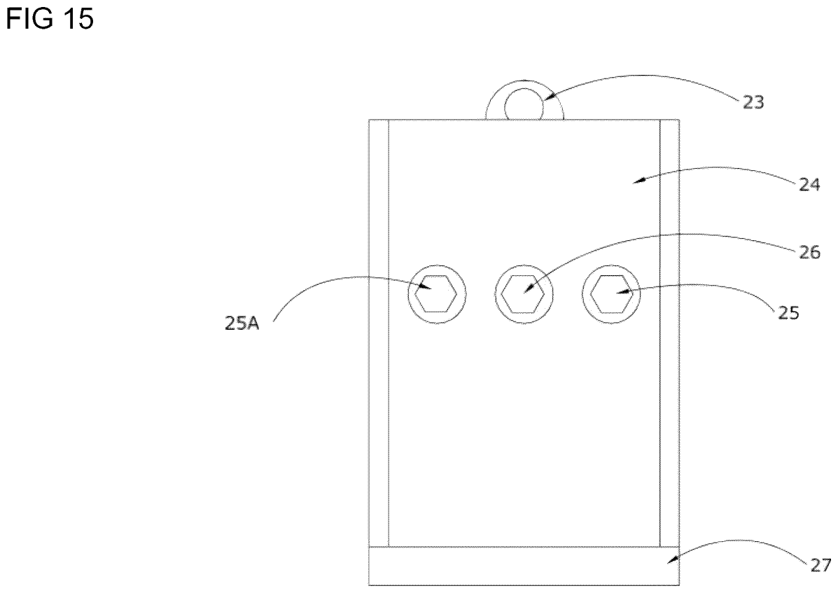

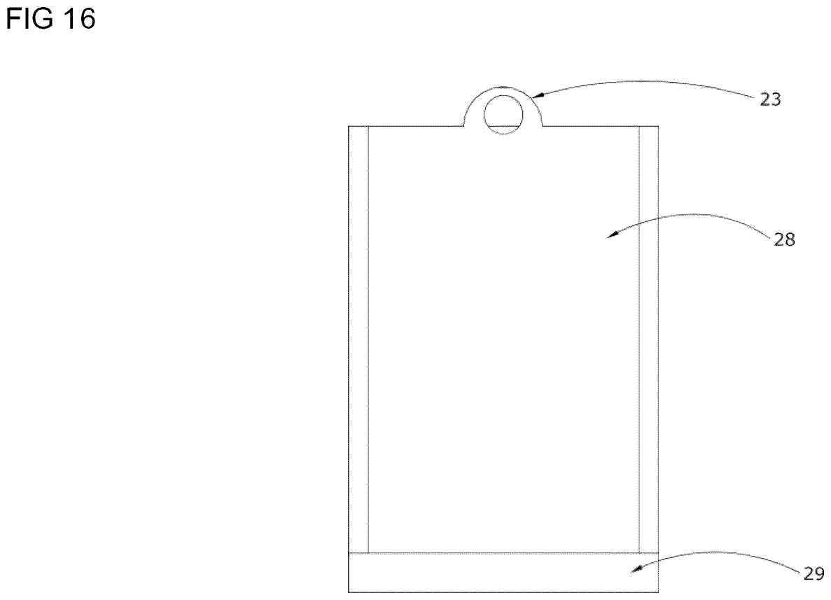

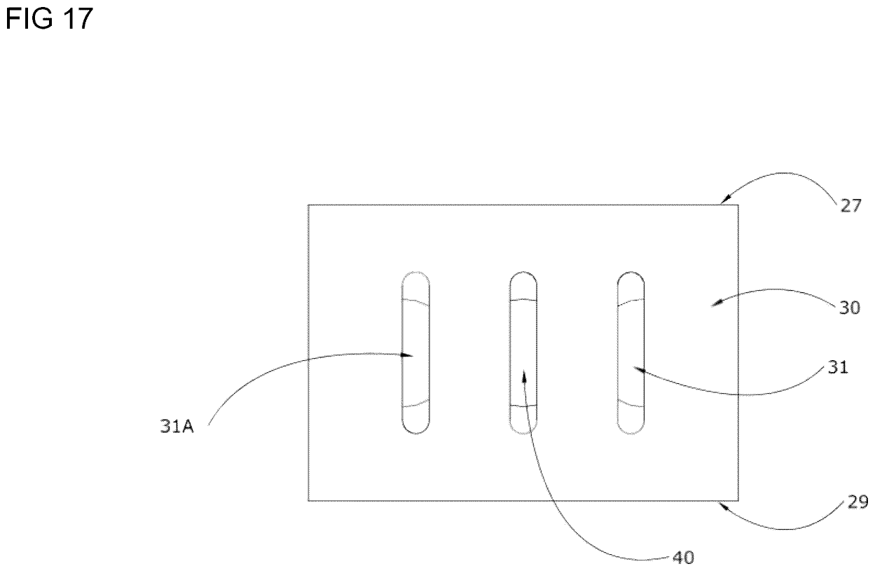

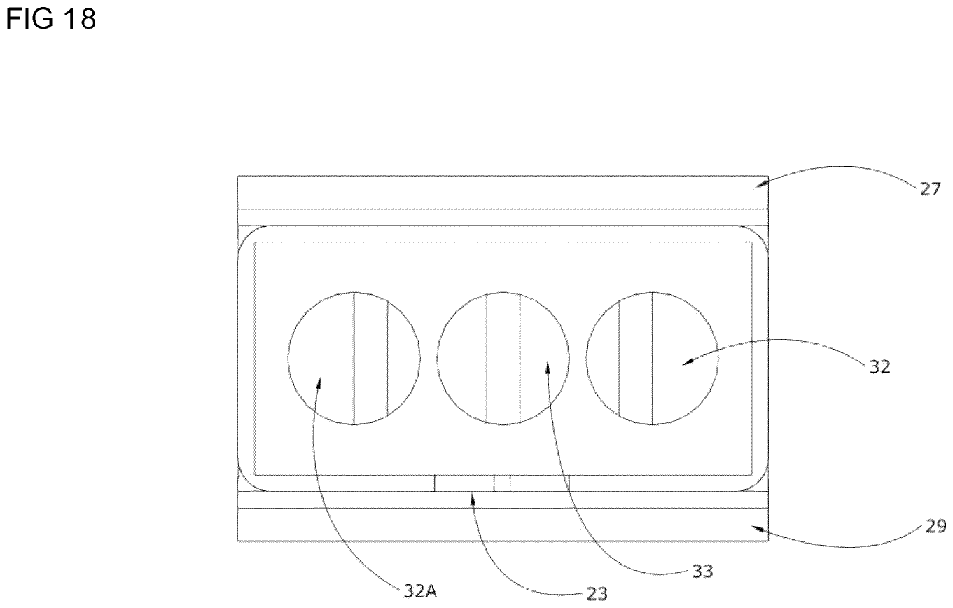

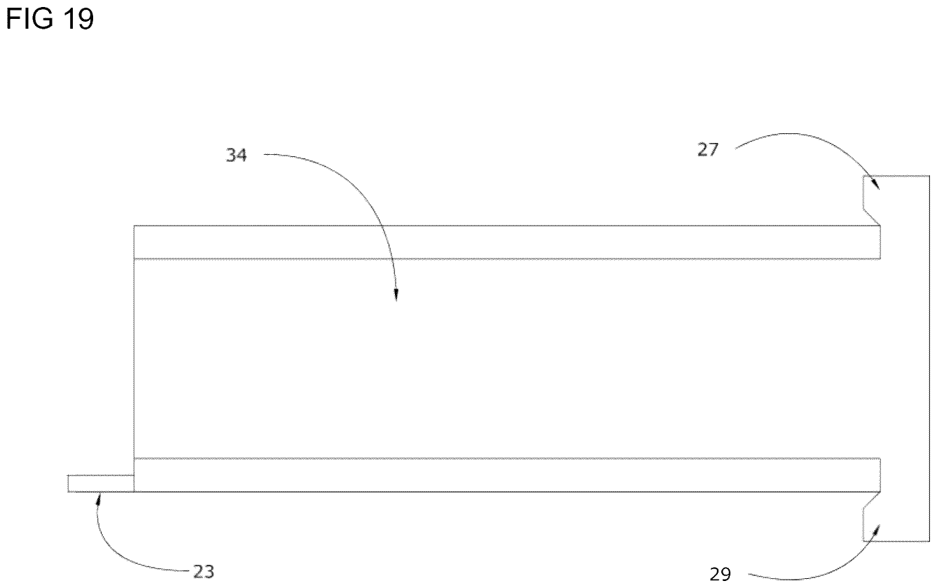

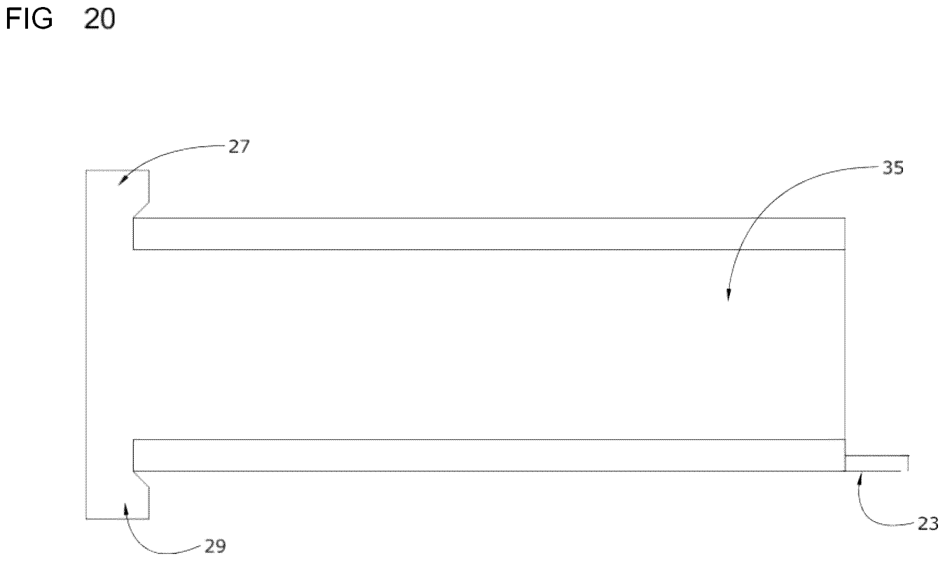

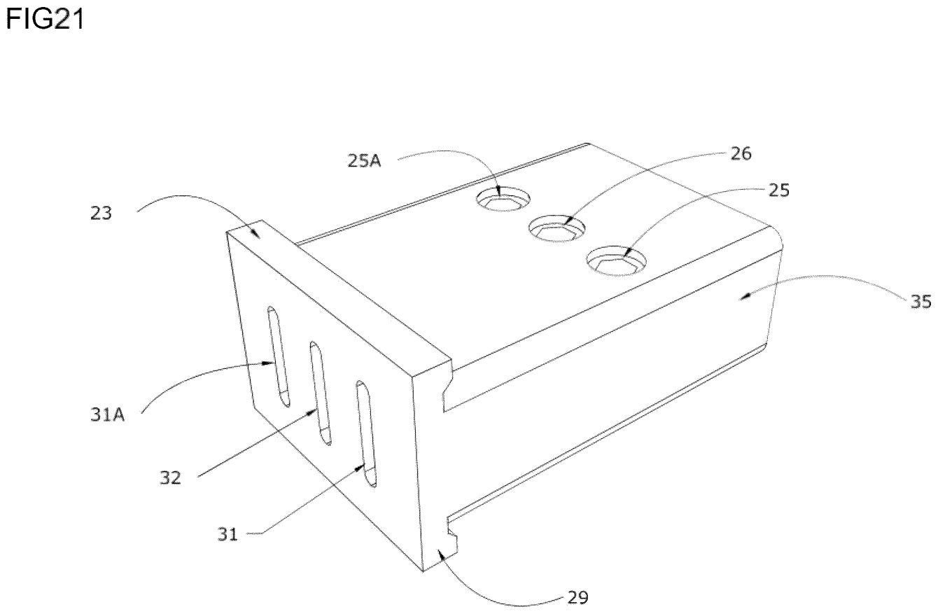

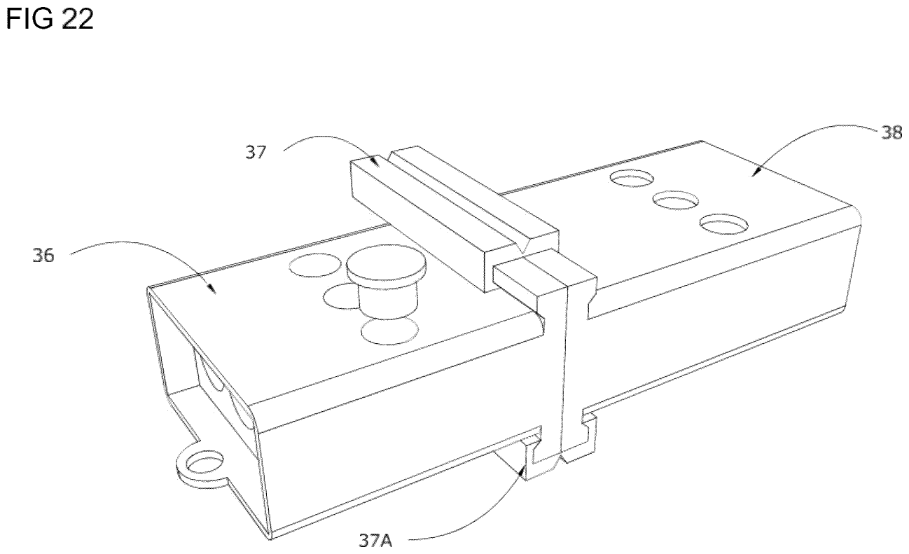

1. The first embodiment of the invention consists of a break-away coupling system composed of a male-side assembly (10) and a female-side assembly (24), joined by a replaceable tension clip (01). As shown in FIGS. 1-22, the tension clip (01) fits over raised and notched exterior surfaces (13, 17 on the male side; 27, 29 on the female side), engaging notches (08) and angled break features (02, 05). The clip includes a central V-groove (02), which is engineered with a controlled depth to break under a specified tensile load, allowing the coupling to separate safely when excess tension is applied to the line.
2. The male-side assembly (10) includes three conductive metal prongs: two shorter prongs (14, 14A) for hot conductors and one longer prong (15) for the neutral conductor. The increased length of the neutral prong ensures that the neutral connection is the last to disengage during separation, improving electrical safety and guaranteeing proper orientation upon reconnection. These prongs are integrated into the lower portion of the prong housing (16), and the interior connections are made by securing the conductor wires using recessed hex grub screws, which are tightened with an Allen key.
3. The conductor wires are inserted through designated ports (18, 18A for hot conductors; 19 for neutral), and held in place by internal grub screws (12, 12A). These screws are covered with rubber sealing caps (4, 4A) to protect against water ingress, corrosion, and accidental contact, ensuring the long-term integrity of the connection in outdoor conditions.
4. The female-side assembly (24) contains internal spring-loaded clamps housed within receptacles (31, 31A for hot conductors; 40 for neutral) that align with and receive the male prongs. These spring-tensioned contact points maintain consistent electrical connection under vibration or movement. Internal wires are secured using additional grub screws (25, 25A for hot; 26 for neutral), which are accessible through conductor openings (32, 32A for hot; 33 for neutral). Mounting loops (09 for the male assembly and 23 for the female assembly) are used to attach the coupling assemblies to overhead hardware, ensuring tension is offloaded from internal conductors and not placed on the electrical terminations.
5. The two assemblies are joined by upper and lower tension clips (37, 37A), shown in FIG. 22, which firmly lock the coupling halves together. When axial force exceeding the clip's rated strength is applied—for example, due to falling trees, severe wind, or utility pole damage—the clip fractures cleanly along its V-groove, and the coupling separates. Only the clip must be replaced to restore functionality.

### Second Embodiment—Shear Pin Coupling

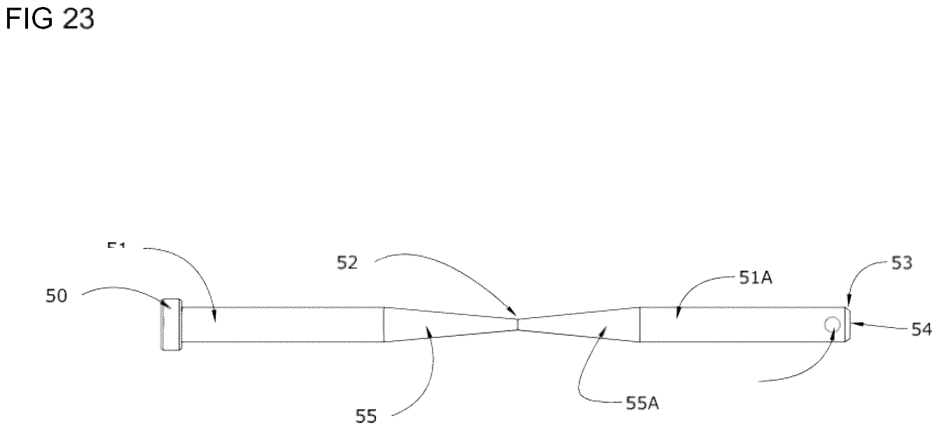

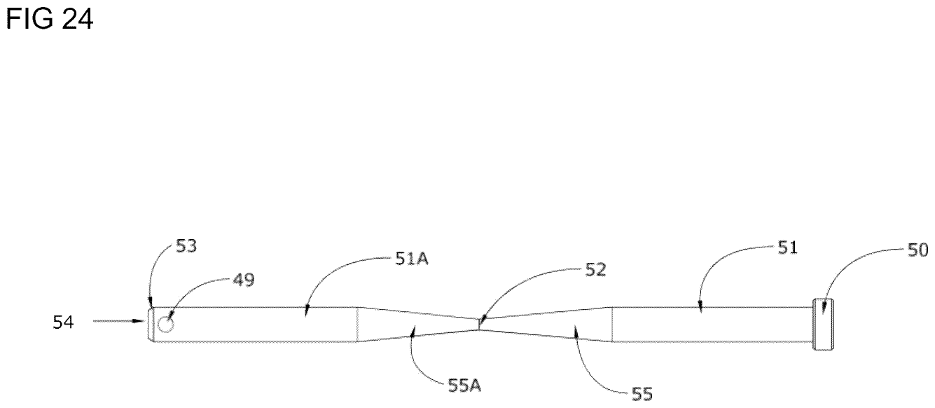

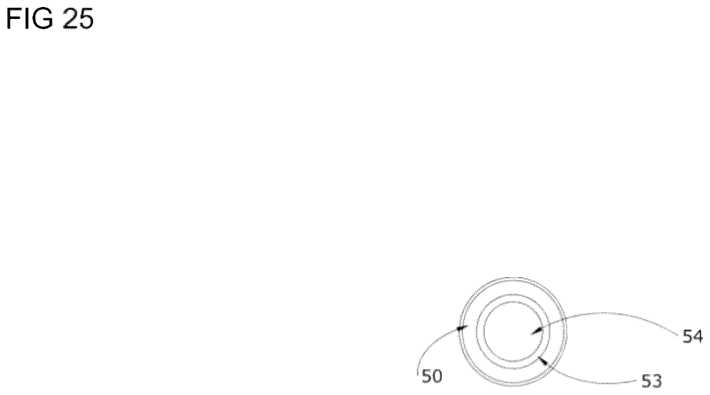

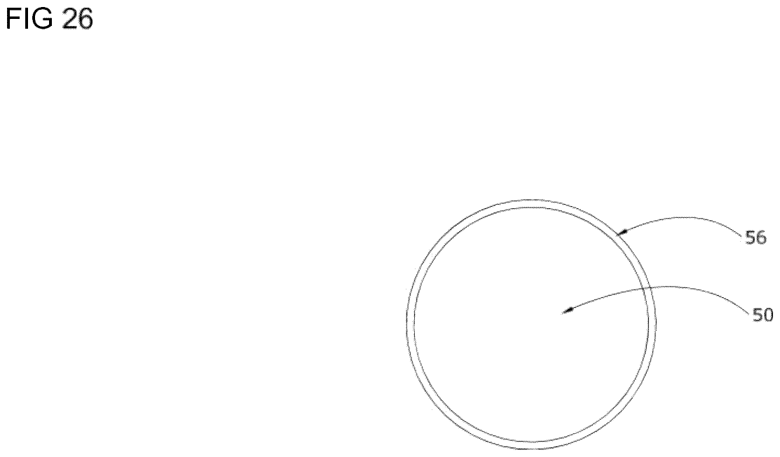

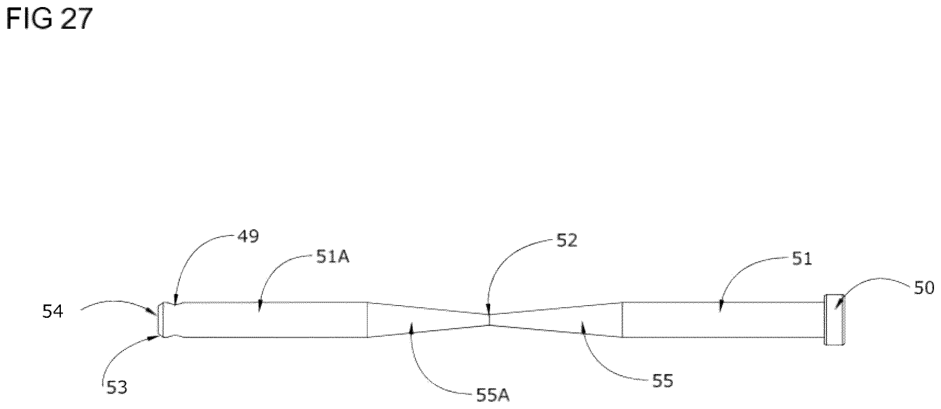

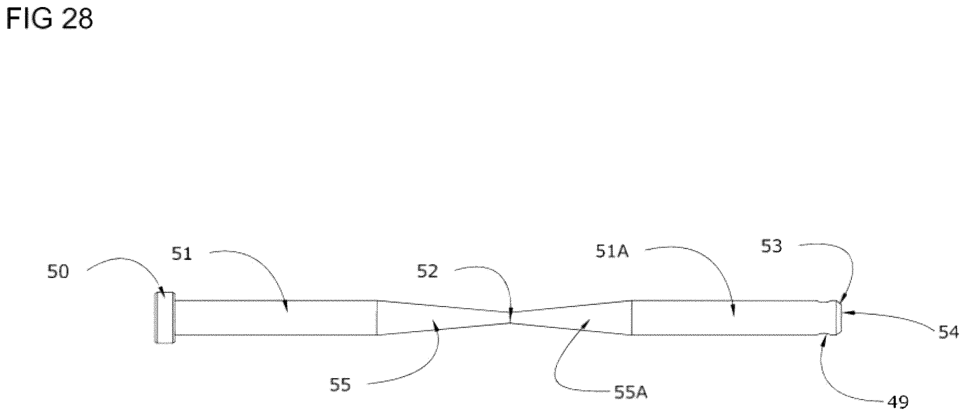

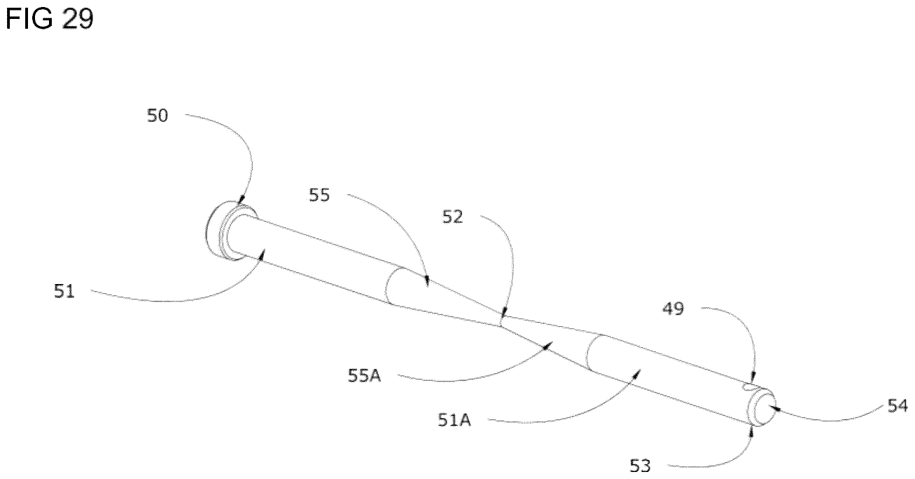

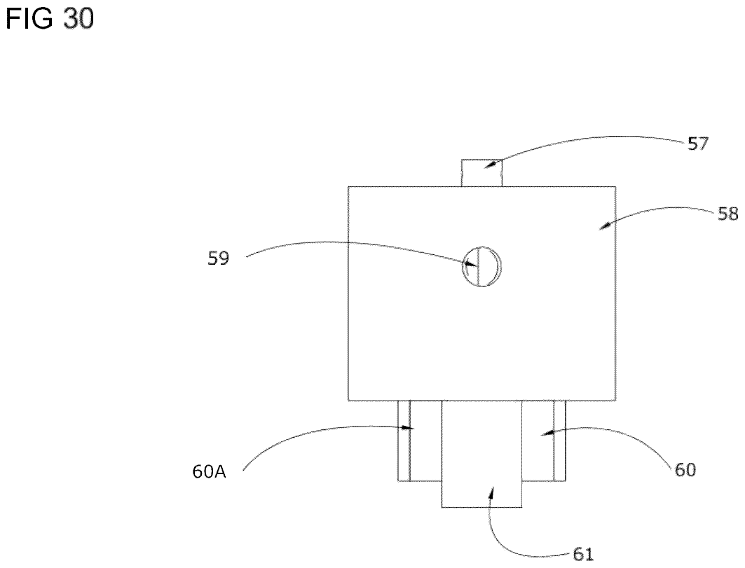

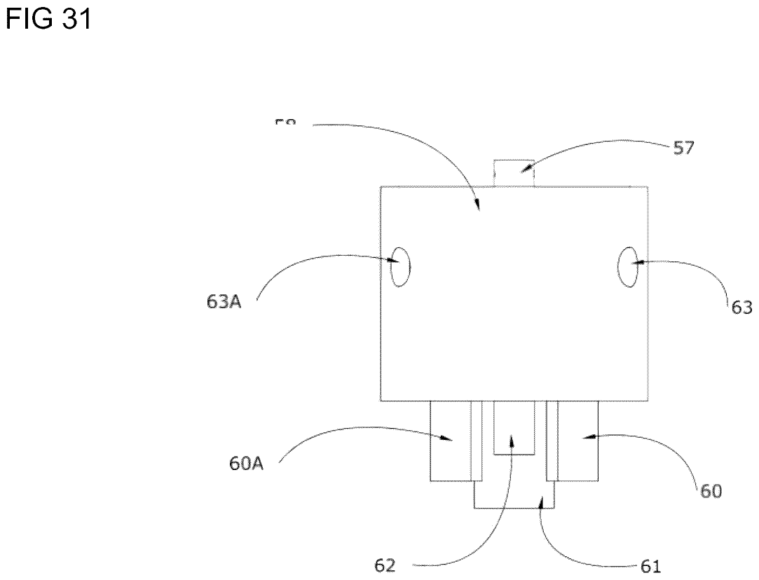

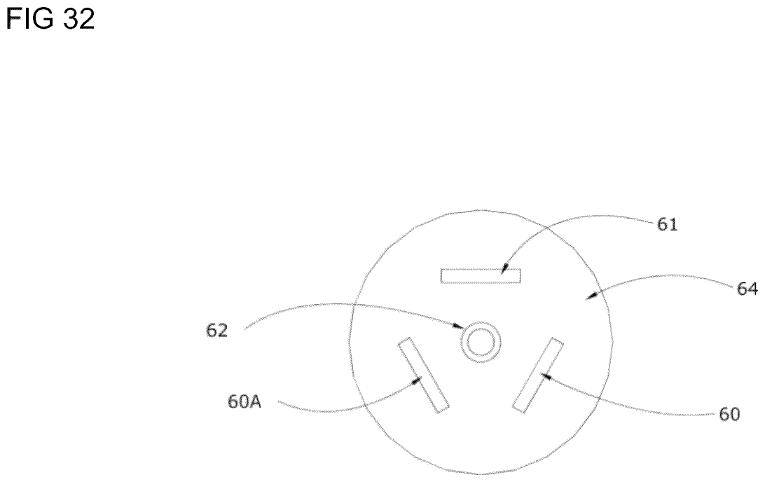

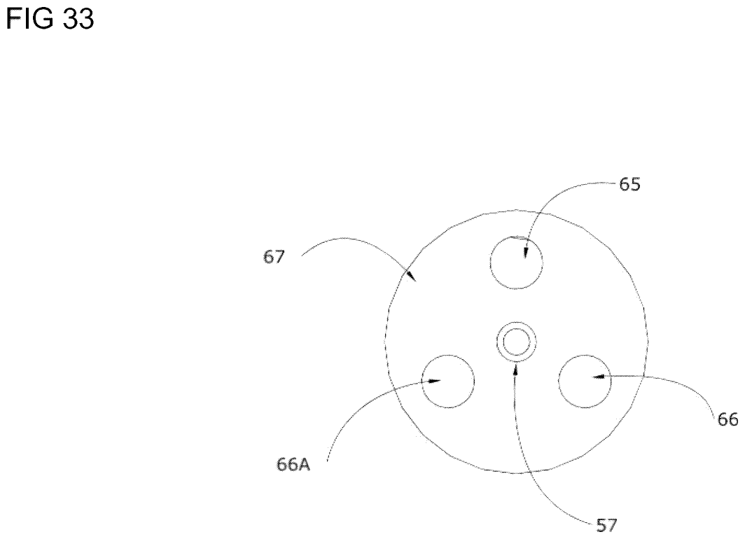

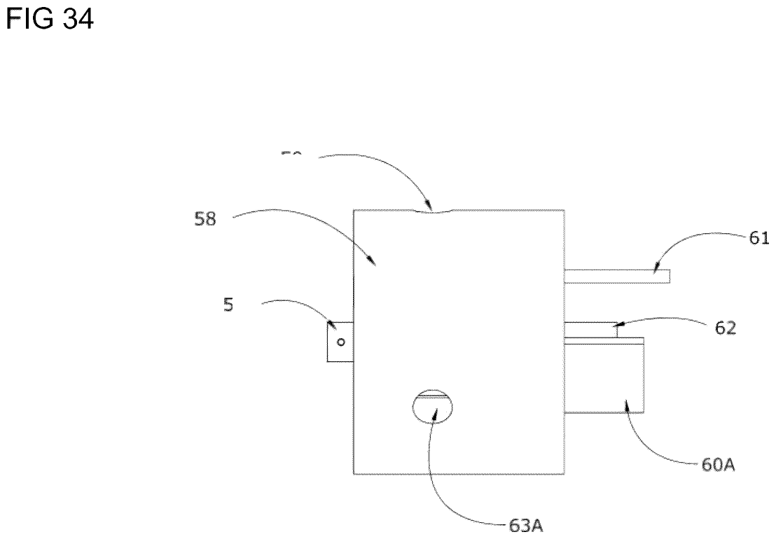

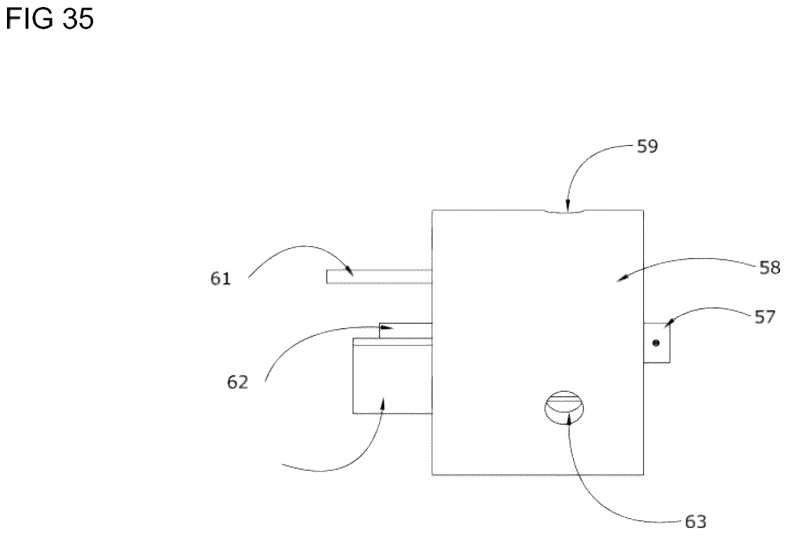

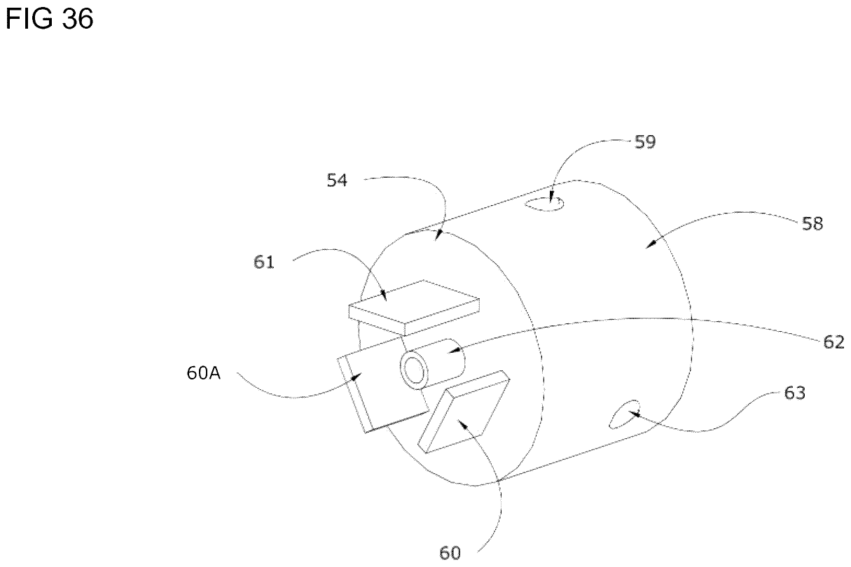

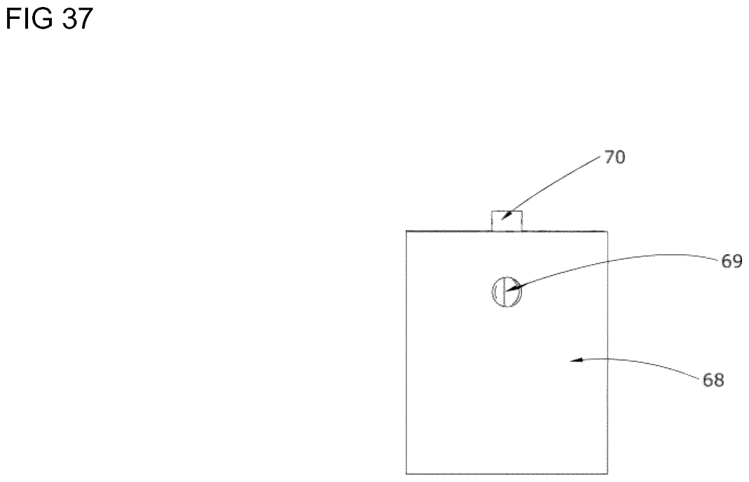

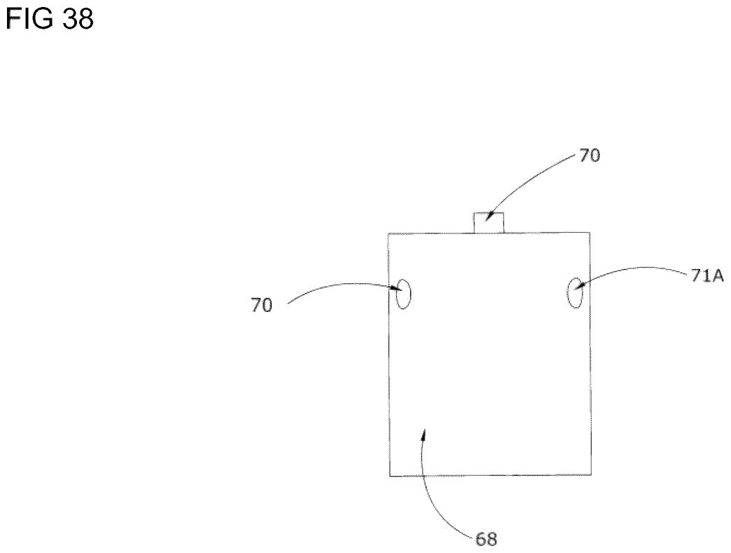

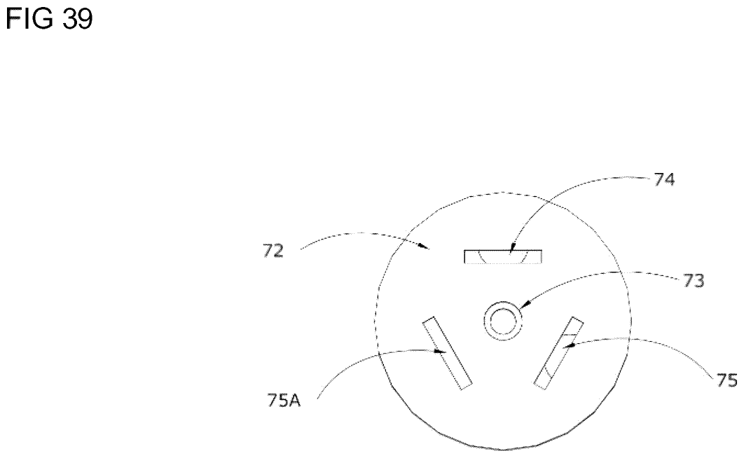

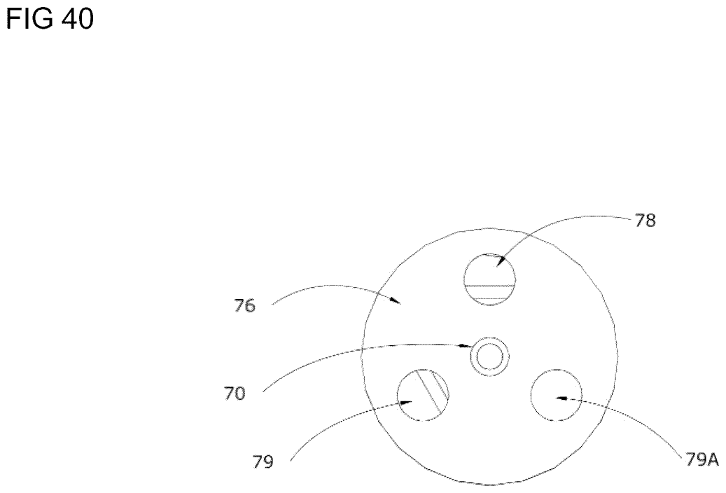

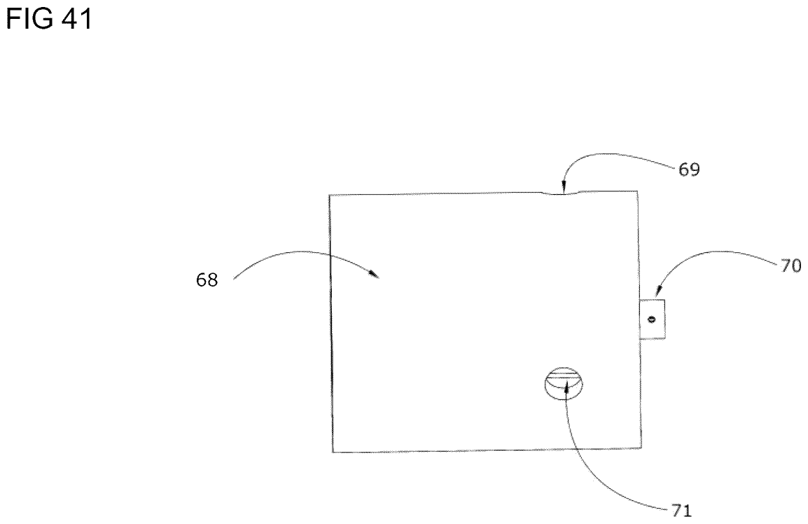

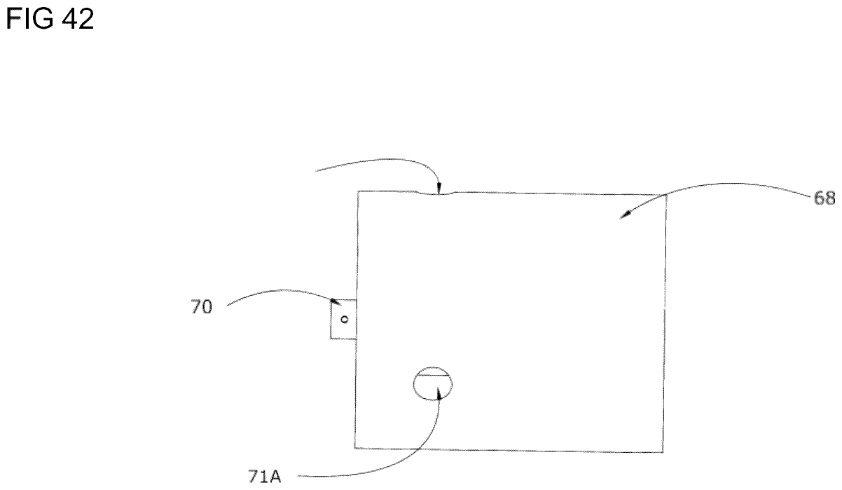

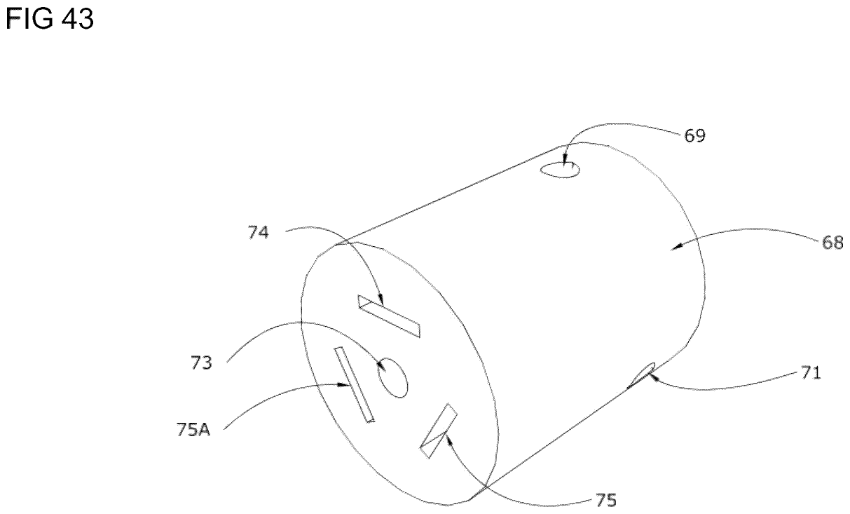

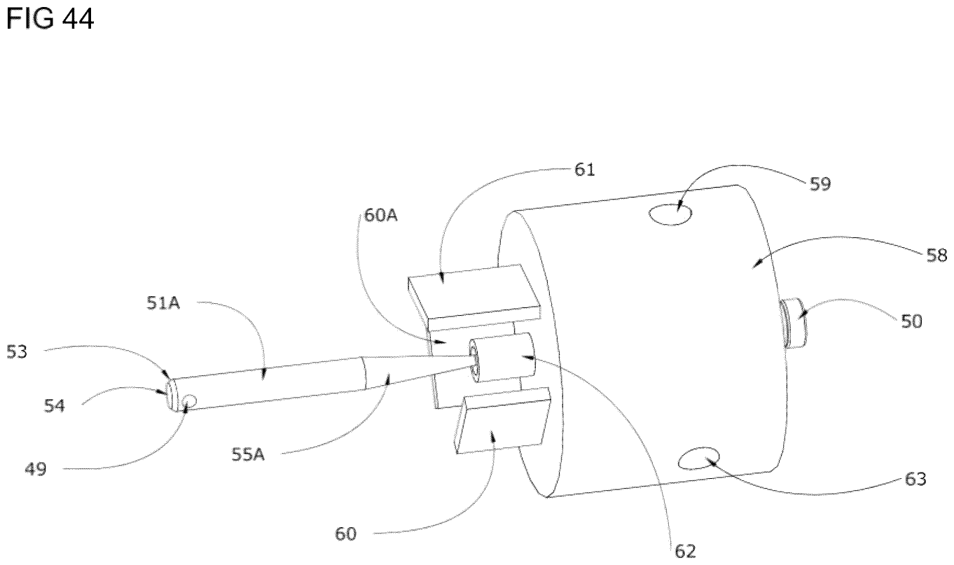

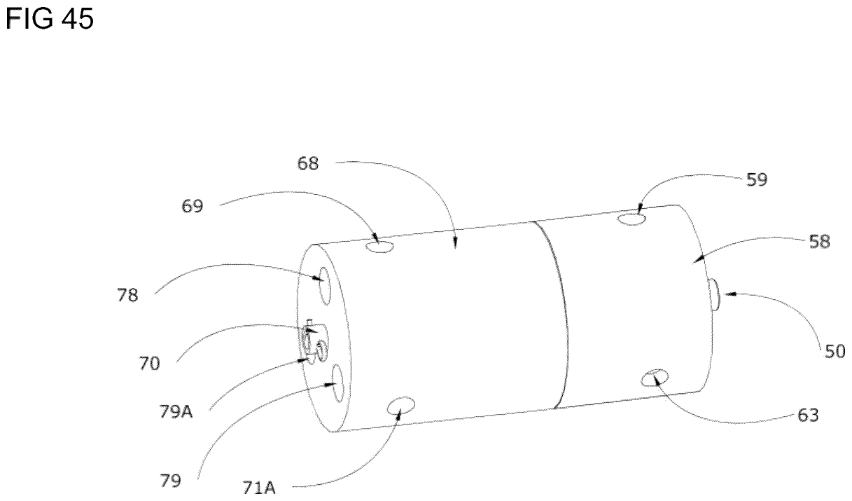

6. In the second embodiment, the coupling is secured by a shear pin rather than a tension clip. This version consists of a male-side assembly (58) and a female-side assembly (68), which are mechanically joined through a shear pin (51). As depicted in FIGS. 23-45, the shear pin includes a button-style head (50), a main shaft (51), and a tapered end (53) for easy insertion. The pin passes through a hole (57) in the male-side assembly and aligns with a receiving hole (70) in the female-side assembly. A central narrowed portion (52) of the pin defines its tensile breaking strength, which is selected according to the expected load conditions in the field.
7. The male-side shear pin assembly (58) includes two shorter hot prongs (60, 60A) and one longer neutral prong (61). As with the tension clip embodiment, the longer neutral prong ensures both proper connection alignment and safe disconnect sequencing. The internal conductor paths are accessed through wire entry points (65, 66 for hot; 66A for neutral), and secured in place using grub screws (59, 63, 63A) with recessed hex slots, allowing secure tightening with a standard Allen key.
8. The female-side shear pin assembly (68) features corresponding spring-loaded contacts (75 for hot; 74 for neutral), which align to receive the male prongs. Alignment between assemblies is assisted by guide pins (62) and slots (73), ensuring a repeatable and secure fit. Electrical terminations on the female side are made using grub screws (69, 71, 71A) accessed via conductor ports (78, 79, 79A). The rear housings (67 on male; 76 on female) are constructed from weatherproof, non-conductive materials to ensure complete environmental sealing and mechanical stability.
9. When axial tension exceeds the shear pin's engineered load, the narrowed midsection (52) fractures and the two assemblies separate. FIGS. 44 and 45 illustrate the shear pin in its installed and assembled states. After separation, the male and female bodies can be reused without damage—only the shear pin needs to be replaced. This design, like the tension clip system, requires no specialized tools and supports fast reconnection.
10. Because the clip and sheer pin is tool-free to install and remove, the system allows for rapid repair and restoration of service in remote or emergency deployment scenarios.

1. (Tension Clip Coupling) A break-away electrical coupling system comprising:
a male coupling comprising a housing and a polarity of conductive prongs,
a longer neutral prong and at least two shorter hot prongs,
a female coupling comprising a housing and a corresponding polarity of spring-loaded receptacles for receiving said prongs,
a removable tension clip configured to mechanically join said male and female couplings together, the tension clip including a V-groove that defines a predetermined mechanical failure point; wherein the tension clip is designed to fracture at a specified axial load, allowing the male and female couplings to separate while maintaining structural integrity of each housing,
and wherein the male and female couplings are configured for reusability following fracture of the tension clip.

2. (Shear Pin Coupling) A break-away electrical coupling system comprising:
a male coupling comprising a housing and a polarity of conductive prongs,
a longer neutral prong and at least two shorter hot prongs,
a female coupling comprising a housing and corresponding receptacles for receiving said prongs,
a shear pin configured to pass through aligned bores in the male and female couplings and to mechanically join the couplings together; wherein the shear pin comprises a narrowed region defining a predetermined tensile failure point, and wherein the shear pin fractures when axial load exceeds a predefined threshold, permitting separation of the couplings while allowing reuse of the male and female housings.

3. (Method of Installation and Use) A method of providing a disconnect table electrical connection between a power source and a load using a break-away coupling system, the method comprising:
Inserting conductor wires into a male coupling and securing them with set screws,
inserting conductor wires into a female coupling and securing them with set screws,
inserting the prongs of the male coupling into the receptacles of the female coupling,
Mechanically joining the couplings using a replaceable tension clip or shear pin, wherein said clip or pin is selected based on a desired mechanical break threshold,
installing the couplings in line with an overhead utility cable, such that mechanical tension is relieved through anchor loops or wedge clamps, and wherein the coupling is configured to separate safely when subjected to excessive axial force,

1. The system of claim 1, wherein the tension clip comprises a U-shaped body with a central V-groove formed to fracture at a break rating between 50 and 250 pounds of force.

2. The system of claim 2, wherein the shear pin comprises a cylindrical body with a reduced-diameter region rated to break between 50 and 250 pounds of axial tension.

3. The system of claims 1 or 2, wherein the neutral prong is longer than the hot prongs to ensure last disconnection and proper alignment.

4. The system of claims 1 or 2, wherein all electrical terminations are sealed with removable rubber caps to prevent water egress and corrosion.

5. The system of claim 3, wherein no specialized tools are required to replace the tension clip or shear pin in the field.

6. The system of claims 1 or 2, wherein the male and female couplings include mounting loops configured for use with overhead wedge clamps.

7. The system of claims 1 or 2, wherein the male and female couplings are formed from weather-resistant polymer or composite materials with embedded corrosion-resistant metal contacts.

8. The system of claim 3, wherein the coupling system is configured for use in temporary field installations including emergency medical response sites, military field operation camps, disaster recovery operations or rapid-deployment electrical systems requiring quick connection and safe disconnection.
